(19) United States
(12) Patent Application Publication
(10) Pub. No.: US 2026/0038898 A1
(43) Pub. Date: Feb. 5, 2026

(54) BATTERY LABEL, BATTERY PACK, AND METHOD OF MANUFACTURING BATTERY LABEL

(71) Applicant: Samsung SDI Co., Ltd., Yongin-si (KR)

(72) Inventors: Sanghun Park, Yongin-si (KR); Dongwook Lee, Yongin-si (KR)

(73) Assignee: Samsung SDI Co., Ltd., Yongin-si (KR)

(21) Appl. No.: 19/189,842

(22) Filed: Apr. 25, 2025

(30) Foreign Application Priority Data
Jul. 31, 2024 (KR) 10-2024-0102165

(51) Int. Cl. H01M 10/48; H01M 10/42; H01M 50/204

(52) U.S. Cl. CPC H01M 10/488; H01M 10/4228; H01M 10/482; H01M 50/204

(57) ABSTRACT

Disclosed are a battery label, a battery pack, and a method of manufacturing the battery label. The battery label may include a discolored paint layer that is provided at the top of an opening formed in a case of a battery and that is discolored in response to exposure to a fluid or heat generated within the battery, a transparent material layer that is provided on the discolored paint layer, and a color printing layer that is provided on the transparent material layer and on which one or more colors have been printed.

### CROSS-REFERENCE TO RELATED APPLICATIONS

This present application claims priority to and the benefit under 35 U.S.C. § 119(a)-(d) of Korean Patent Application No. 10-2024-0102165, filed on Jul. 31, 2024, in the Korean Intellectual Property Office, the entire disclosure of which is incorporated herein by reference.

### FIELD

The present disclosure relates to a battery label, including a discolored paint layer that is discolored in response to a fluid or heat within a battery, a battery pack including the battery label, and a method of manufacturing the battery label.

### BACKGROUND

Unlike primary batteries that are not designed to be charged, secondary batteries designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly comprises a positive electrode and a negative electrode, a case that accommodates the electrode assembly, a terminal part connected to the electrode assembly.

The above information disclosed in this Background section is for enhancement of understanding of the background of the present disclosure, and therefore, it may contain information that does not constitute related (or prior) art.

### SUMMARY

Various embodiments are directed to providing a battery label including a discolored paint layer that is discolored in response to a fluid or heat within a battery, a battery pack, and a method of manufacturing the battery label.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

A battery label according to embodiments of the present disclosure may include a discolored paint layer that is provided at the top of an opening formed in a case of a battery and that is discolored in response to exposure to a fluid or heat generated within the battery, a transparent material layer that is provided on the discolored paint layer, and a color printing layer that is provided on the transparent material layer and on which one or more colors have been printed.

In embodiments, the battery label may further include a laminating layer that is provided on the color printing layer and that protects the one or more colors printed on the color printing layer.

In embodiments, the battery label may further include an adhesive layer provided between the opening formed in the case of the battery and the discolored paint layer.

In embodiments, the discolored paint layer may be provided only on a portion corresponding to the opening formed in the case of the battery.

In embodiments, a silver ink layer may be provided in an area at the bottom of the transparent material layer and does not overlap the discolored paint layer.

In embodiments, the discolored paint layer may, before the discolored paint layer is discolored in response to exposure to the fluid or heat generated within the battery, have a color identical to a color of the case of the battery.

In embodiments, the discolored paint layer may include nano micro capsules that respond to the fluid or heat generated within the battery.

A battery pack according to embodiments of the present disclosure may include a plurality of battery cells, a case that accommodates the plurality of battery cells and in which an opening is formed, and a battery label that is attached to the case to cover the opening of the case. The battery label may include a discolored paint layer that is provided at the top of the opening formed in the case and that is discolored in response to exposure to a fluid or heat generated within the case, a transparent material layer that is provided on the discolored paint layer, and a color printing layer that is provided on the transparent material layer and on which one or more colors have been printed.

In embodiments, the battery label may further include a laminating layer that is provided on the color printing layer and that protects the one or more colors printed on the color printing layer.

In embodiments, the battery label may further include an adhesive layer provided between the opening formed in the case and the discolored paint layer.

In embodiments, the discolored paint layer may be provided only on the top of a portion corresponding to the opening formed in the case.

In embodiments, the battery label may include a silver ink layer provided in an area at the bottom of the transparent material layer and the silver ink layer does not overlap the discolored paint layer.

In embodiments, before the discolored paint layer is discolored in response to exposure to the fluid or heat generated within the case, the discolored paint layer has a color identical to a color of the case of the battery.

In embodiments, the discolored paint layer may include nano micro capsules that respond to the fluid or heat generated within the case.

A method of manufacturing a battery label according to embodiments of the present disclosure may include providing a discolored paint layer that is discolored in response to exposure to a fluid or heat generated within a battery at the top of an opening that is formed in a case of the battery, providing a transparent material layer on the discolored paint layer, and providing, on the top of the transparent material layer, a color printing layer on which one or more colors have been printed.

In embodiments, the method of manufacturing a battery label may further include providing, on a top of the color printing layer, a laminating layer that protects the one or more colors printed on the color printing layer.

In embodiments, the method of manufacturing a battery label may further include providing an adhesive layer between the opening formed in the case of the battery and the discolored paint layer.

In embodiments, the providing of the discolored paint layer may include providing the discolored paint layer only on a portion corresponding to the opening formed in the case of the battery.

In embodiments, the method of manufacturing a battery label may further include providing a silver ink layer in an area at the bottom of the transparent material layer wherein the silver ink layer does not overlap the discolored paint layer. In embodiments, the providing of the discolored paint layer may include providing the discolored paint layer including nano micro capsules that respond to the fluid or heat generated within the battery.

According to embodiments of the present disclosure, the battery label including the discolored paint layer that is provided at the top of the opening formed in the case of a battery and that is discolored in response to a fluid or heat generated within the battery is provided. Accordingly, a user can detect a danger in a battery cell before the state of the battery cell enters a thermal runaway state due to a short within the battery cell or external power.

According to embodiments of the present disclosure, the discolored paint layer is discolored in response to exposure to a fluid or heat within a battery before the state of a battery cell enters a thermal runaway state. Accordingly, the ignition of the battery cell attributable to the abnormalities of the supply of power, such as abnormal charging and discharging, can be fundamentally prevented because a user can detect a danger without the need for a separate thermal or gas detector.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate preferred embodiments of the present disclosure, and help to further understand the technical spirit of the present disclosure along with the aforementioned contents of the disclosure. Accordingly, the present disclosure should not be construed as being limited to only contents described in such drawings:

FIG. 1 is a schematic diagram illustrating a cylindrical lithium secondary battery according to an example embodiment.

FIG. 2 schematic diagram illustrating a prismatic lithium secondary battery according to an example embodiment.

FIGS. 3 and 4 are schematic diagrams illustrating a pouch type lithium secondary battery according to example embodiment.

FIG. 5 is a cross-sectional diagram of a battery label according to a first embodiment of the present disclosure.

FIG. 6 is a cross-sectional diagram of a battery label according to a second embodiment of the present disclosure.

FIG. 7 is a diagram for describing a method of detecting, by a user, a danger in a battery cell based on the battery label according to embodiments of the present disclosure.

FIG. 8 is a flowchart for describing a method of manufacturing a battery label according to embodiments of the present disclosure.

### DETAILED DESCRIPTION

Exemplary embodiments of the present disclosure will be described below in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own invention in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments. Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art. It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions. The terminology used herein is for the purpose of describing embodiments of the present disclosure and is not intended to limit the present disclosure.

The type of secondary battery includes a coin type, a cylindrical type, a prismatic type, and a pouch type. Prior to a description of embodiments of the present disclosure, first, cylindrical and prismatic secondary batteries are roughly described because the present disclosure may be basically applied to the cylindrical and prismatic secondary batteries.

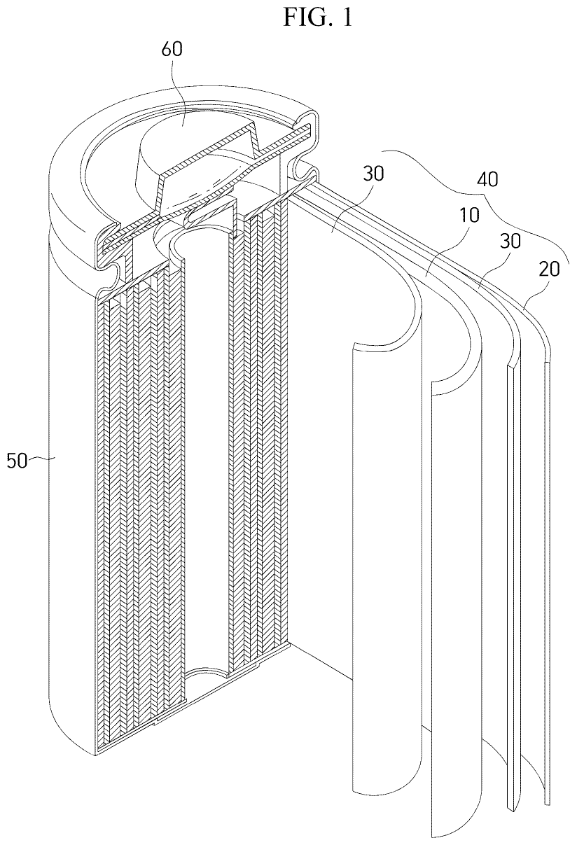

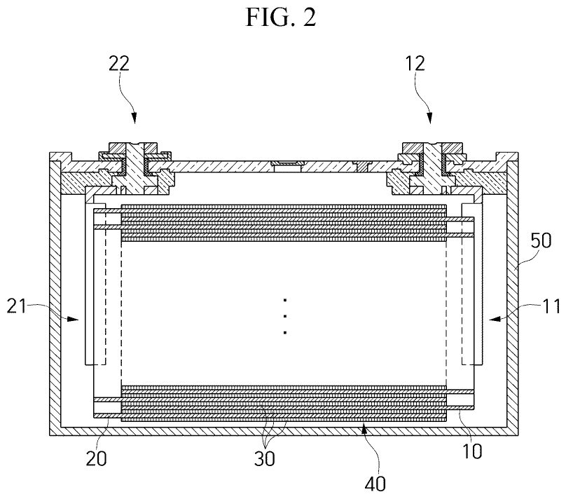

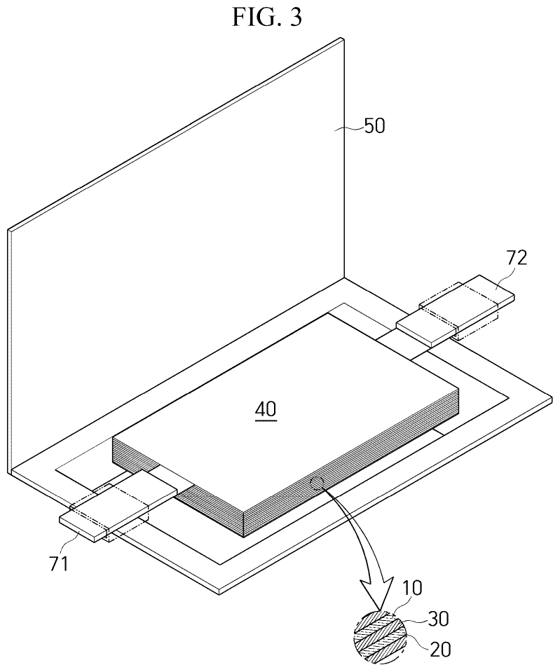

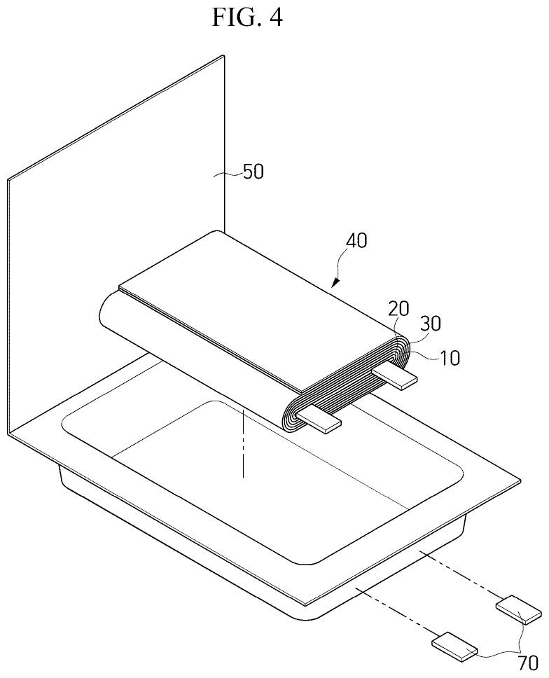

In a battery pack including a plurality of secondary batteries, a label in which an electrical capacity and the size of power of the battery pack and other information, such as precautions for use of the battery pack, are written is attached to the battery pack so that a user can be aware of the corresponding information. Furthermore, the label also serves to cover the parting line or gate of the battery pack. FIGS. 1 to 4 are schematic diagrams illustrating lithium secondary batteries according to some embodiments. FIG. 1 illustrates an example of a cylindrical lithium secondary battery. FIG. 2 illustrates an example of a prismatic type secondary battery. FIGS. 3 and 4 illustrate examples of a pouch type secondary battery. Referring to FIGS. 1 to 4, a lithium secondary battery 1 may include an electrode assembly 40 in which a separator 30 has been interposed between a first electrode plate 10 and a second electrode plate 20 and a case 50 in which the electrode assembly 40 has been embedded. The first electrode plate 10, the second electrode plate 20, and the separator 30 may be impregnated in an electrolyte (not illustrated). As illustrated in FIG. 1, the lithium secondary battery 1 may include a sealing member 60 that seals the case 50. Furthermore, in FIG. 2, the lithium secondary battery 1 may include a first electrode lead tab 11, a first electrode terminal 12, a second electrode lead tab 21, and a second electrode terminal 22. As illustrated in FIGS. 3 and 4, the lithium secondary battery 1 may include an electrode tab 70 that plays a role as an electrical passage for inducing a current formed in the electrode assembly 40 toward the outside of the electrode assembly 40, that is, a first electrode tab 71 and a second electrode tab 72.

The electrode assembly 40 may be formed by winding or stacking a stack body including the first electrode plate 10, the second electrode plate 20, and the separator 30 each of which is formed in a plate or film shape. In the case of the winding stack body, the winding axis of the electrode assembly 40 may be parallel to the length direction of the case. Furthermore, in some embodiments, the electrode assembly 40 may be the stack type not the winding type, but a shape of the electrode assembly 40 is not limited thereto. The first electrode plate 10 of the electrode assembly 40 may play a role as a positive electrode, and the second electrode plate 20 thereof may play a role as a negative electrode, and vice versa.

The first electrode plate 10 may be formed by applying a first electrode active material, such as graphite or carbon, to a first electrode collector plate formed of metal foil, such as copper, a copper alloy, nickel, or a nickel alloy, and may include a first electrode tab (or a first uncoated part), that is, an area to which the first electrode active material has not been applied.

The second electrode plate 20 may be formed by applying a second electrode active material, such as transition metal oxide, to a material formed of metal foil, such as aluminum or an aluminum alloy, and may include a second electrode tab (or a second uncoated part), that is, an area to which the second electrode active material has not been applied.

The separator 30 may function to prevent a short-circuit between the first electrode plate 10 and the second electrode plate 20 while permitting a movement of lithium ions. The separator 30 may be composed of a polyethylene film, a polypropylene film, or a polyethylene-polypropylene film, for example.

A plurality of secondary batteries, which has been described by taking FIGS. 1 to 4 as examples, may be assembled together to form a plurality of battery cells, and may constitute a battery pack along with a case that accommodates the plurality of battery cells. A battery label according to embodiments of the present disclosure may be attached to the case of a battery cell or the case of the battery pack so that a user can detect a danger in the battery cell or the battery pack before the state of the battery cell or the battery pack enters a thermal runaway state. A battery label according to embodiments of the present disclosure and a method of manufacturing the battery label are described with reference to the accompanying drawings.

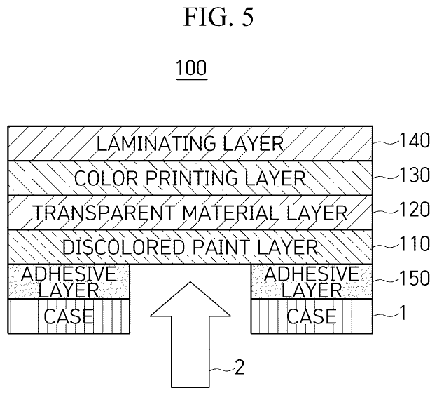

FIG. 5 is a cross-sectional diagram of a battery label according to a first embodiment of the present disclosure.

Referring to FIG. 5, a battery label 100 according to embodiments of the present disclosure may include a discolored paint layer 110, a transparent material layer 120, a color printing layer 130, a laminating layer 140, and an adhesive layer 150.

The discolored paint layer 110 may be provided at the top of an opening formed in the case 1 of a battery, and may be discolored in response to a fluid or heat 2 within the battery. An electrolyte may leak from the inside of a battery cell prior to the thermal runaway of the battery, or a gas may be generated right before the ignition of the battery cell. The discolored paint layer 110 may be discolored in response to such a fluid within the battery. Furthermore, heat may be generated within the battery cell prior to the thermal runaway of the battery. The discolored paint layer 110 may be discolored in response to such heat within the battery. Accordingly, a user can detect a danger in the battery before the state of the battery becomes a thermal runaway state. The discolored paint layer 110 may be provided at the top of the opening formed in the case 1 of the battery. The opening may be the parting line or gate of the case 1 of the battery.

In embodiments, the discolored paint layer 110 may include nano micro capsules that respond to a fluid or heat within a battery. In embodiments, the discolored paint layer 110 has the same color as the case 1 of the battery before the discolored paint layer is discolored in response to a fluid or heat within the battery, and has a different color as the nano micro capsules are destructed when a fluid or heat within the battery is generated. The nano micro capsule includes a material having good visibility so that a user can recognize with certainty when the discolored paint layer 110 is discolored when the nano micro capsules are destroyed. Furthermore, the nano micro capsules may each have a diameter of about 150 um. In embodiments, the nano micro capsule may include NOVEC 1230 FK-5-1-12.

The transparent material layer 120 may be provided on the discolored paint layer 110 so that a color of the discolored paint layer 110 before the discolored paint layer 110 is discolored and a color of the discolored paint layer 110 after the discolored paint layer 110 is discolored can be clearly distinguished. In embodiments, the transparent material layer 120 may be made of a transparent polyethylene terephthalate (PET) material.

The color printing layer 130 may be provided on the transparent material layer. One or more colors may be printed on the color printing layer 130. Artwork related to a battery may be printed on the color printing layer 130, or an electrical capacity and size of power of a battery and such as precautions for use of the other information, battery, may be printed on the color printing layer 130.

The laminating layer 140 may be provided on the color printing layer 130, and may protect the one or more colors of the color printing layer 130. The laminating layer 140 may serve to prevent the color printing layer 130 from being contaminated or peeled off because the laminating layer 140 is coated on the color printing layer 130.

The adhesive layer 150 may be provided between the opening that is formed in the case 1 of the battery and the discolored paint layer 110, and may serve to allow the battery label 100 according to embodiments of the present disclosure to adhere well to the case 1 of the battery.

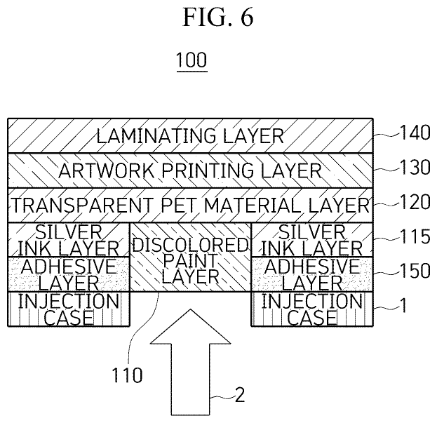

FIG. 6 is a cross-sectional diagram of a battery label according to a second embodiment of the present disclosure. Referring to FIG. 6, a battery label 100 according to embodiments of the present disclosure may include a discolored paint layer 110, a silver ink layer 115, a transparent polyethylene terephthalate (PET) material layer 120, a color printing layer 130, a laminating layer 140, and an adhesive layer 150.

The discolored paint layer 110 may be provided at the top of an opening formed in a case 1 of a battery, and may be discolored in response to a fluid or heat 2 within the battery. An electrolyte may leak from the inside of a battery cell prior to the thermal runaway of the battery, or a gas may be generated right before the ignition of the battery cell. The discolored paint layer 110 may be discolored in response to such a fluid within the battery. Furthermore, heat may be generated within the battery cell prior to the thermal runaway of the battery. The discolored paint layer 110 may be discolored in response to such heat within the battery. Accordingly, a user can detect a danger in the battery before the state of the battery enters a thermal runaway state. The discolored paint layer 110 may be provided at the top of the opening formed in the case 1 of the battery. The opening may be the parting line or gate of the case 1 of the battery.

In embodiments, the discolored paint layer 110 may include nano micro capsules that respond to a fluid or heat within a battery. In embodiments, the discolored paint layer 110 has the same color as the case 1 of the battery before the discolored paint layer is discolored in response to a fluid or heat within the battery, and has a different color as the nano micro capsules are destroyed when a fluid or heat within the battery is generated. The nano micro capsule includes a material having good visibility so that a user can recognize with certainty that the discolored paint layer 110 is discolored when the nano micro capsules are destroyed. Furthermore, the nano micro capsules may each have a diameter of about 150 um. In embodiments, the nano micro capsule may include NOVEC 1230 FK-5-1-12.

In the embodiment of FIG. 6, the discolored paint layer 110 may be provided only on the top of a portion corresponding to the opening formed in the case 1 of the battery. In this case, when the discolored paint layer 110 is discolored in response to a fluid or heat within the battery, the discolored paint layer 110 is discolored only along the opening. Accordingly, a cost of manufacturing the battery can be reduced because the waste of a discoloration paint that is used in the discolored paint layer 110 can be prevented by reducing the amount of discoloration paint used, while still ensuring that a portion at which abnormality occurs can be easily checked.

Furthermore, the silver ink layer 115 may be provided in an area of the bottom of the transparent material layer 120 except the discolored paint layer 110. The silver ink layer 115 allows a color of the color printing layer 130 to be well exposed. Furthermore, the silver ink layer 115 allows contents printed on the color printing layer 130 to be clearly recognized by a user, because the case 1 of the battery is a metal material, in general, and thus has silver and the discolored paint layer 110 has the same color as the case 1 of the battery before the discolored paint layer 110 is discolored.

The transparent material layer 120 may be provided on a top of the discolored paint layer 110 so that the color before discoloration and the color after discoloration of the discolored paint layer 110 may be clearly recognized. In embodiments, the transparent material layer may be made of a transparent polyethylene terephthalate (PET) material.

The color printing layer 130 may be provided on the top of the transparent material layer. One or more colors may be printed on the color printing layer 130. Artwork related to a battery may be printed on the color printing layer 130, or an electrical capacity and size of power of a battery and other information, such as precautions for use of the battery, may be printed on the color printing layer 130.

The laminating layer 140 may be provided on the top of the color printing layer 130, and may protect the one or more colors printed on the color printing layer 130. The laminating layer 140 may serve to prevent the color printing layer 130 from being contaminated or peeled off because the laminating layer 140 is coated on the color printing layer 130.

The adhesive layer 150 may be provided between the opening formed in the case 1 of the battery and the discolored paint layer 110, and may serve to allow the battery label 100 according to embodiments of the present disclosure to adhere well to the case 1 of the battery.

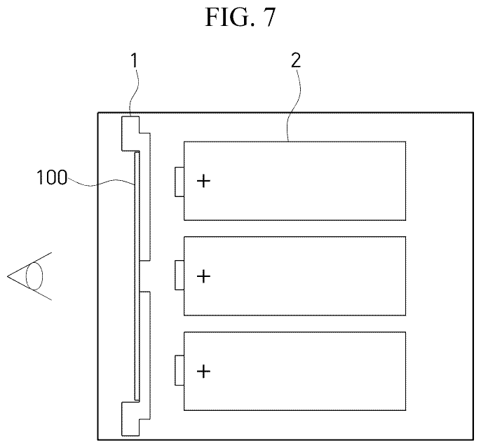

FIG. 7 is a diagram for describing a method of detecting, by a user, a danger in a battery cell based on the battery label according to embodiments of the present disclosure.

Referring to FIG. 7, the battery label 100 according to embodiments of the present disclosure is attached to the case 1 that accommodates the battery cell 2. When a fluid leaks from the inside of the battery cell 2 or heat is generated within the battery cell 2 because an abnormality occurs in the battery cell 2, the discolored paint layer 110 of the battery label 100 attached to the case 1 is discolored in response to the leakage of the fluid or the generation of the heat. A user can recognize that abnormality has occurred in the battery cell 2 by checking the discolored battery label 100, and can take precautions by recognizing that the state of the battery cell 2 may enter a thermal runaway state.

According to embodiments of the present disclosure, the battery label 100 including the discolored paint layer 110 that is provided at the top of the opening formed in the case 1 of a battery and that is discolored in response to a fluid or heat within the battery is provided. Accordingly, a user can detect a danger in a battery cell before the state of the battery cell enters a thermal runaway state due to a short within the battery cell or external power.

According to embodiments of the present disclosure, the discolored paint layer 110 is discolored in response to a fluid or heat within a battery before the state of a battery cell enters a thermal runaway state. Accordingly, the ignition of the battery cell attributable to the abnormalities of the supply of power, such as abnormal charging and discharging, can be fundamentally prevented because a user can detect a danger without the need for a separate thermal or gas detector.

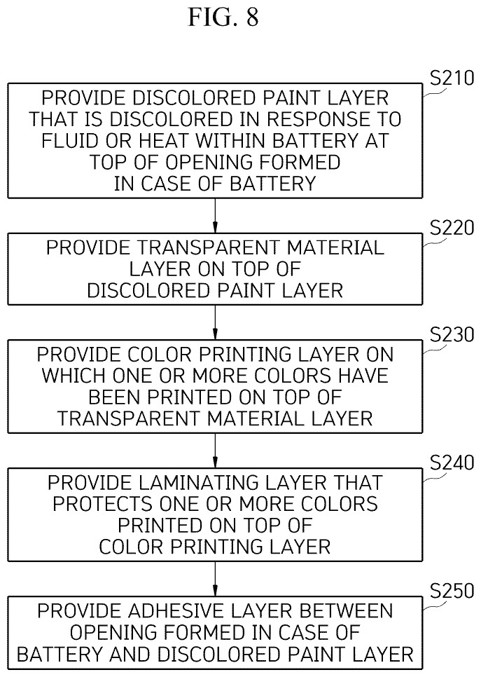

FIG. 8 is a flowchart for describing a method of manufacturing a battery label according to embodiments of the present disclosure.

As illustrated in FIG. 8, the method of manufacturing a battery label according to embodiments of the present disclosure may include steps S210 to S250.

Step S210 is a step of providing the discolored paint layer that is discolored in response to a fluid or heat within a battery at the top of the opening formed in the case of the battery. In embodiments, step S210 may include providing the discolored paint layer including nano micro capsules that respond to a fluid or heat within the battery.

Step S220 is a step of providing the transparent material layer on the top of the discolored paint layer.

Step S230 is a step of providing the color printing layer on which one or more colors have been printed on the top of the transparent material layer.

Step S240 is a step of providing the laminating layer that protects the one or more colors printed on the top of the color printing layer.

Step S250 is a step of providing the adhesive layer between the opening formed in the case of the battery and the discolored paint layer.

The method of manufacturing a battery label according to embodiments of the present disclosure has been described with reference to the flowcharts presented in the drawings. For a simple description, the method has been illustrated and described as a series of blocks, but the present disclosure is not limited to the sequence of the blocks, and some blocks may be performed in a sequence different from or simultaneously with that of other blocks, which has been illustrated and described in this specification. Various other branches, flow paths, and sequences of blocks which achieve the same or similar results may be implemented. Furthermore, in some embodiments, not all the blocks illustrated in order to implement the method described in this specification may be required.

In the description given with reference to FIG. 8, each of the steps may be further divided into additional steps or the steps may be combined into fewer steps depending on an embodiment of the present disclosure. Furthermore, some of the steps may be omitted, if necessary, and the sequence of the steps may be changed. Furthermore, the contents of FIGS. 1 to 7, although some contents are omitted from the contents of FIGS. 1 to 7, may be applied to the contents of FIG. 8. Furthermore, the contents of FIG. 8 may be applied to the contents of FIGS. 1 to 7.

Hereinafter, materials which may be used in a secondary battery according to an embodiment of the present disclosure are described.

A compound (e.g., a lithiated intercalation compound) capable of reversible intercalation and deintercalation of lithium may be used as a positive electrode active material. Specifically, one or more types of material selected among complex oxides of metal, selected among cobalt, manganese, nickel, and a combination thereof, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination thereof.

For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤α≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂ (PO₄)₃ (0≤f≤2); and LiₐFePO₄ (0.90≤a≤1.8).

In the chemical formula, A may be Ni, Co, Mn, or a combination thereof. X may be Al, Ni, Co, Mn, Cr, Fe, Mg, Sr, V, a rare earth element, or a combination thereof; D may be O, F, S, P, or a combination thereof. G may be Al, Cr, Mn, Fe, Mg, La, Ce, Sr, V, or a combination thereof. L¹ may be Mn, Al, or a combination thereof.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %. Al may be used as the current collector, but the present disclosure may not be limited thereto.

A negative electrode active material may include a material capable of reversible intercalation/de-intercalation with respect to lithium ions, lithium metal, an alloy of lithium metal, a material capable of doping and dedoping with respect to lithium, or transition metal oxide.

The material capable of reversible intercalation/de-intercalation with respect to lithium ions may include a carbon-based negative electrode active material, for example, crystalline carbon, amorphous carbon, or a combination thereof. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to an embodiment, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99 wt. %, the binder of 0.5 wt. % to 5 wt. %, and the conductive material of 0 wt. % to 5 wt. %.

A nonaqueous-based binder, an aqueous-based binder, a dry binder, or a combination thereof may be used as the binder. If the aqueous-based binder is used as a binder for the negative electrode, the binder for the negative electrode may further include a cellulose-series compound capable of assigning viscosity.

A material selected among nickel foil, stainless steel foil, titanium foil, nickel foam, copper foam, a polymer base on which a conductive metal has been coated, and a combination thereof may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination thereof. The carbonate-based, ester-based, ether-based, ketone-based, or alcohol-based solvent, or the aprotic solvent may be used solely, or two types or more thereof may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers thereof may be used as the separator.

The separator may include a porous base, and a coating layer including an organic matter, an inorganic matter, or a combination thereof that is disposed on one or both sides of the porous base.

The organic matter may include a polyvinylidene fluoride-based heavy antibody or (meth)acrylic polymer.

The inorganic matter may include inorganic particles selected among Al₂O₃, SiO₂, TiO₂, SnO₂, CeO₂, MgO, Nio, Cao, GaO, Zno, ZrO₂, Y₂O₃, SrTiO₃, BaTiO₃, Mg(OH)₂, boehmite, and a combination thereof, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described above in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. A battery label comprising:
a discolored paint layer that is provided at a top of an opening formed in a case of a battery and that is discolored in response to exposure to a fluid or heat generated within the battery;
a transparent material layer that is provided on a top of the discolored paint layer; and
a color printing layer that is provided on a top of the transparent material layer and on which one or more colors have been printed.

2. The battery label as claimed in claim 1, further comprising a laminating layer that is provided on a top of the color printing layer and that protects the one or more colors printed on the color printing layer.

3. The battery label as claimed in claim 1, further comprising an adhesive layer provided between the opening formed in the case of the battery and the discolored paint layer.

4. The battery label as claimed in claim 1, wherein the discolored paint layer is provided only on a top of a portion corresponding to the opening formed in the case of the battery.

5. The battery label as claimed in claim 4, wherein a silver ink layer is provided in an area at a bottom of the transparent material layer and does not overlap the discolored paint layer.

6. The battery label as claimed in claim 1, wherein, before the discolored paint layer is discolored in response to exposure to the fluid or heat generated within the battery, the discolored paint layer has a color identical to a color of the case of the battery.

7. The battery label as claimed in claim 1, wherein the discolored paint layer comprises nano micro capsules that respond to the fluid or heat generated within the battery.

8. A battery pack comprising:
a plurality of battery cells;
a case that accommodates the plurality of battery cells and in which an opening is formed; and
a battery label that is attached to the case to cover the opening of the case,
wherein the battery label comprises a discolored paint layer that is provided at a top of the opening formed in the case and that is discolored in response to exposure to a fluid or heat generated within the case, a transparent material layer that is provided on the discolored paint layer, and a color printing layer that is provided on the transparent material layer and on which one or more colors have been printed.

9. The battery pack as claimed in claim 8, wherein the battery label further comprises a laminating layer that is provided on a top of the color printing layer and that protects the one or more colors printed on the color printing layer.

10. The battery pack as claimed in claim 8, wherein the battery label further comprises an adhesive layer provided between the opening formed in the case and the discolored paint layer.

11. The battery pack as claimed in claim 8, wherein the discolored paint layer is provided only on a top of a portion corresponding to the opening formed in the case.

12. The battery pack as claimed in claim 11, wherein the battery label comprises a silver ink layer provided in an area at a bottom of the transparent material layer and the silver ink layer does not overlap the discolored paint layer.

13. The battery pack as claimed in claim 8, wherein, before the discolored paint layer is discolored in response to exposure to the fluid or heat generated within the case, the discolored paint layer has a color identical to a color of the case.

14. The battery pack as claimed in claim 8, wherein the discolored paint layer comprises nano micro capsules that respond to the fluid or heat generated within the case.

15. A method of manufacturing a battery label, comprising:
providing a discolored paint layer that is discolored in response to exposure to a fluid or heat generated within a battery at a top of an opening that is formed in a case of the battery;
providing a transparent material layer on a top of the discolored paint layer; and
providing, on a top of the transparent material layer, a color printing layer on which one or more colors have been printed.

16. The method as claimed in claim 15, further comprising providing, on a top of the color printing layer, a laminating layer that protects the one or more colors printed on the color printing layer.

17. The method as claimed in claim 15, further comprising providing an adhesive layer between the opening formed in the case of the battery and the discolored paint layer.

18. The method as claimed in claim 15, wherein the providing of the discolored paint layer comprises providing the discolored paint layer only on a top of a portion corresponding to the opening formed in the case of the battery.

19. The method as claimed in claim 18, further comprising providing a silver ink layer in an area at a bottom of the transparent material layer wherein the silver ink layer does not overlap the discolored paint layer.

20. The method as claimed in claim 15, wherein the providing of the discolored paint layer comprises providing the discolored paint layer comprising nano micro capsules that respond to the fluid or heat generated within the battery.
